(19) United States
(12) Patent Application Publication
(10) Pub. No.: US 2026/0057008 A1
(43) Pub. Date: Feb. 26, 2026

(54) METHOD AND SYSTEM FOR ZERO-SHOT COMPOSED IMAGE RETRIEVAL

(71) Applicant: ELECTRONICS AND TELECOMMUNICATIONS RESEARCH INSTITUTE, Daejeon (KR)

(72) Inventor: Seongwon LEE, Daejeon (KR)

(21) Appl. No.: 19/066,627

(22) Filed: Feb. 28, 2025

(30) Foreign Application Priority Data
Aug. 22, 2024 (KR) 10-2024-0112685

(51) Int. Cl. G06F 16/532; G06F 40/205; G06F 40/289; G06F 40/40

(52) U.S. Cl. CPC G06F 16/532; G06F 40/205; G06F 40/289; G06F 40/40

(57) ABSTRACT

Provided are a zero-shot composed image retrieval method and system. The zero-shot composed image retrieval method which is performed by the zero-shot composed image retrieval system includes acquiring, by a zero-shot composed image retrieval system, an image embedding by inputting an input image into a visual encoder, generating, by the zero-shot composed image retrieval system, an image-projected token by inputting the image embedding into a projection module, generating, by the zero-shot composed image retrieval system, a composed string based on a pre-trained base prompt, the image-projected token, a pre-trained condition prompt, and input text, generating, by the zero-shot composed image retrieval system, a composed embedding by inputting the composed string into a text encoder, and extracting, by the zero-shot composed image retrieval system, one candidate image from among a plurality of candidate images that are retrieval targets using the composed embedding.

### CROSS-REFERENCE TO RELATED APPLICATION

This application claims priority to and the benefit of Korean Patent Application No. 10-2024-0112685, filed on Aug. 22, 2024, the disclosure of which is incorporated herein by reference in its entirety.

### BACKGROUND

### 1. Field of the Invention

The present invention relates to a composed image retrieval technology that retrieves images using images and text as inputs in the field of artificial intelligence. Specifically, the present invention relates to a composed image retrieval technology to which a text-only training technique is applied among zero-shot techniques.

### 2. Description of Related Art

When retrieving images through a general search engine, text is usually input to retrieve images (text-based image retrieval). Text-based image retrieval has a problem in that it is difficult to accurately find the desired image due to the limitations of expression. To solve this problem, composed image retrieval systems and methods, which combine image and text inputs for retrieval, have been proposed.

However, in order to train a composed image retrieval system, a large amount of triple data consisting of input images, descriptive text, and correct images should be provided, which is inefficient. To improve this, Google Research has developed a zero-shot learning method that trains a composed image retrieval system using only image-text data without data, and has proposed a method of efficiently training a composed image retrieval system by reducing the burden of data collection costs.

In order to reduce the cost and effort of constructing a dataset and to perform efficient training of a composed image retrieval system, a method of training a composed image retrieval system using only text, without using any image data at all, has been proposed among zero-shot training techniques. This training method has been improved so that a composed image retrieval system can be trained only with text for training without any training images having the long processing time and large capacity, which shows a remarkable improvement in the overall training efficiency.

However, the above-mentioned zero-shot training method and the text-only training method both use predefined connection prompts (e.g., “a photo of,” “that”) to construct inputs for the retrieval system when connecting image information and data information. Such predefined prompts have the problem that they can reduce the expressiveness and adaptability of a model, and further reduce the performance of the model and its responsiveness to various image and text expressions.

### SUMMARY OF THE INVENTION

The present invention relates to a method and system for retrieving an image by inputting an image and text. The present invention is directed to providing a zero-shot composed image retrieval method and system that apply a prompt learning technique.

The purpose of the present invention is not limited to the purpose mentioned above, and other purposes that are not mentioned will be clearly understood by those skilled in the art from the description below.

The present invention relates to a zero-shot composed image retrieval method and system. According to an aspect of the present invention, there is provided a zero-shot composed image retrieval method performed by a zero-shot composed image retrieval system, the method including: acquiring an image embedding by inputting an input image into a visual encoder; generating an image-projected token by inputting the image embedding into a projection module; generating a composed string based on a pre-trained base prompt, the image-projected token, a pre-trained condition prompt, and input text; generating a composed embedding by inputting the composed string into a text encoder; and extracting one candidate image from among a plurality of candidate images that are retrieval targets using the composed embedding.

In one embodiment of the present invention, the visual encoder and the text encoder may be multimodal encoders in which the formats of the output embeddings are the same.

In one embodiment of the present invention, the generating of the composed string may include generating, by the zero-shot composed image retrieval system, a text modifier based on input text; and generating, by the zero-shot composed image retrieval system, the composed string by sequentially combining the base prompt, the image-projected token, the condition prompt, and the text modifier.

In one embodiment of the present invention, the zero-shot composed image retrieval method may further include: receiving, by the zero-shot composed image retrieval system, training input text and generating base text and condition text based on a word extracted from the training input text; generating, by the zero-shot composed image retrieval system, a base text embedding by inputting the base text into the text encoder, and generating a pseudo image-projected token by inputting the base text embedding into the projection module; generating, by the zero-shot composed image retrieval system, a training composed string based on a pre-trained base prompt, the pseudo image-projected token, a pre-trained condition prompt, and the condition text, and generating a training composed embedding by inputting the training composed string into the text encoder; generating, by the zero-shot composed image retrieval system, a training input text embedding by inputting the training input text into the text encoder; and training, by the zero-shot composed image retrieval system, the pre-trained base prompt and the pre-trained condition prompt using a loss function value calculated with the training composed embedding and the training input text embedding.

According to another aspect of the present invention, there is provided a method of training a zero-shot composed image retrieval system, the method including: receiving, by the zero-shot composed image retrieval system, training input text and generating base text and condition text based on a word extracted from the training input text; generating, by the zero-shot composed image retrieval system, a base text embedding by inputting the base text into a text encoder and generating a pseudo image-projected token by inputting the base text embedding into a projection module; generating, by the zero-shot composed image retrieval system, a composed string based on a base prompt, the pseudo image-projected token, a condition prompt, and the condition text and generating a composed embedding by inputting the composed string into the text encoder; generating, by the zero-shot composed image retrieval system, a training input text embedding by inputting the training input text into the text encoder; and training, by the zero-shot composed image retrieval system, the base prompt and the condition prompt using a loss function value calculated with the composed embedding and the training input text embedding.

In one embodiment of the present invention, the generating of the base text and the condition text may include assigning the word to one of the base text and the condition text based on the part of speech of the word.

In one embodiment of the present invention, the generating of the base text and the condition text may include assigning the word to one of the base text and the condition text according to a predetermined discrete probability distribution when the part of speech of the word is one of an adjective or a noun.

In one embodiment of the present invention, the generating of the composed embedding may include generating, by the zero-shot composed image retrieval system, the composed string by sequentially combining the base prompt, the pseudo image-projected token, the condition prompt, and the condition text.

In one embodiment of the present invention, the generating of the composed embedding may include generating, by the zero-shot composed image retrieval system, the composed string by sequentially combining the base prompt, the pseudo image-projected token, the condition prompt, and a numeric coding result of the condition text.

In one embodiment of the present invention, the loss function value may be a mean squared error (MSE) loss between the training composed embedding and the training input text embedding.

According to still another aspect of the present invention, there is provided a zero-shot composed image retrieval system including: a memory configured to store computer-readable commands; and at least one processor implemented to execute the commands.

The at least one processor may be configured to, by executing the commands, acquire an image embedding by inputting an input image into a visual encoder, generate an image-projected token by inputting the image embedding to a projection module, generate a composed string based on a pre-trained base prompt, the image-projected token, a pre-trained condition prompt, and input text, generate a composed embedding by inputting the composed string into a text encoder, and extract one candidate image from among a plurality of candidate images that are retrieval targets using the composed embedding.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a retrieval method of a zero-shot composed image retrieval system using only language according to the related art.

FIG. 2 is a diagram illustrating a method of training a zero-shot composed image retrieval system using only language according to the related art.

FIG. 3 is a diagram illustrating a method of a zero-shot composed image retrieval system according to one embodiment of the present invention.

FIG. 4 is a diagram illustrating a method of training a zero-shot composed image retrieval system according to one embodiment of the present invention.

FIG. 5 is a diagram illustrating a configuration of a zero-shot composed image retrieval system for implementing a zero-shot composed image retrieval method according to one embodiment of the present invention.

### DETAILED DESCRIPTION OF EXEMPLARY EMBODIMENTS

The present invention relates to a composed image retrieval technique that retrieves images using images and text as inputs in the field of artificial intelligence. In the present invention, a text-only training methodology is applied among the zero-shot techniques that enable efficient training without expensive dataset collection. The present invention relates to a method and system that can retrieve similar images with high accuracy in a composed image retrieval system by applying a prompt learning technique.

Advantages and features of the present invention and methods for achieving them will be made clear from embodiments described in detail below with reference to the accompanying drawings. However, the present invention may be embodied in many different forms and should not be construed as being limited to the embodiments set forth herein. Rather, these embodiments are provided so that this disclosure will be thorough and complete and will fully convey the scope of the present invention to those of ordinary skill in the technical field to which the present invention pertains. The present invention is defined by the claims. Meanwhile, terms used herein are for the purpose of describing the embodiments and are not intended to limit the present invention. As used herein, the singular forms include the plural forms as well unless the context clearly indicates otherwise. The term “comprise” or “comprising” used herein does not preclude the presence or addition of one or more elements, steps, operations, and/or devices other than stated elements, steps, operations, and/or devices.

The terms “first,” “second,” etc. may be used to describe various components, but the components should not be limited by the terms. The terms may be named only for the purpose of distinguishing one component from another, for example, without departing from the scope of the right according to the subject matter of the present disclosure. A first component may be referred to as a second component. Similarly, a second component may also be referred to as a first component.

It will be understood that, when a component is referred to as being “connected” or “coupled” to another component, it may be directly connected or coupled to the other component, or yet another component may intervene between them. On the other hand, when a component is referred to as being “directly connected” or “directly coupled” to another component, it should be understood that there is no other component between them. Other expressions that describe a relationship between components, such as “between” and “just between” or “adjacent to” and “directly adjacent to” should be interpreted likewise.

In describing the present invention, the detailed description of a related known configuration or function will be omitted when it obscures the gist of the present invention.

Hereinafter, embodiments of the present invention will be described in detail with reference to the attached drawings. In order to facilitate overall understanding in describing the present invention, the same reference numbers will be used for the same means throughout the drawings.

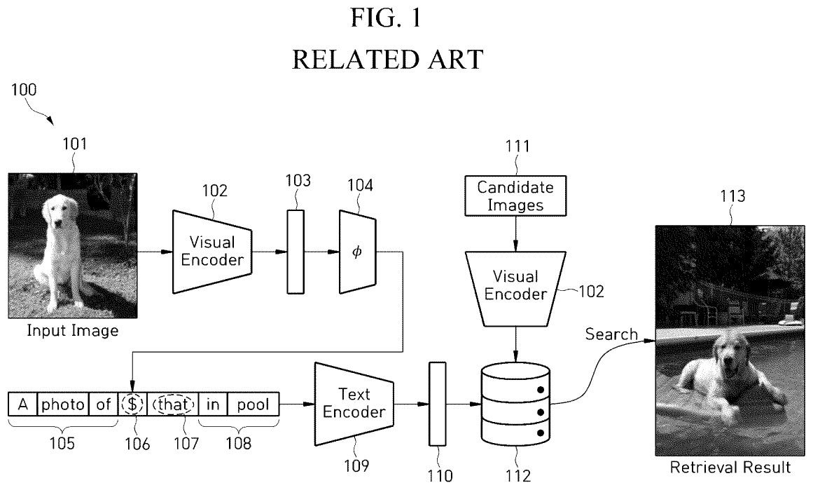

FIG. 1 is a diagram illustrating a retrieval method of a zero-shot composed image retrieval system using only language according to the related art (reference: Kuniaki Saito et al., “Pic2Word: Mapping Pictures to Words for Zero-shot Composed Image Retrieval,” https://doi.org/10.48550/arXiv.2302.03084, 2023).

When an input image 101 is given, a zero-shot composed image retrieval system 100 using only language according to the related art inputs the input image 101 into a visual encoder 102 to acquire an image embedding 103. The image embedding 103 is input into a trained projection module 104 and converted into an image-projected token 106.

Next, the zero-shot composed image retrieval system 100 generates a composed string to be input into a text encoder by connecting a fixed base prompt 105 (e.g., “A photo of”) with the image-projected token 106, and a fixed condition prompt 107 with a text modifier 108. The text modifier 108 is text input by a user or an external system. Here, the fixed base prompt 105, the fixed condition prompt 107, and the text modifier 108 may be replaced with values obtained by each text being converted into numeric information using a predetermined function instead of the text illustrated in FIG. 1.

Next, the zero-shot composed image retrieval system 100 inputs a composed string to which the fixed base prompt 105, the image-projected token 106, the fixed condition prompt 107, and the text modifier 108 are connected, into a text encoder 109 to extract a composed embedding 110. Here, the fixed base prompt 105 and the fixed condition prompt 107 are not trained and are pre-designated on the zero-shot composed image retrieval system 100.

Meanwhile, before the above-described process is performed, it is assumed that the zero-shot composed image retrieval system 100 receives a group of candidate images 111 to be retrieved and stores the embedding acquired through the visual encoder 102 in an image database 112.

Finally, the zero-shot composed image retrieval system 100 may retrieve images most similar to a corresponding input as an extraction result 113 by comparing the composed embedding 110 with the embedding of the candidate image group 111 previously stored in the image database 112.

The conventional zero-shot composed image retrieval system 100 and the retrieval method using the same have the disadvantage that their adaptability and expandability are limited because the base prompt 105 and the condition prompt 107 are not trained but fixed in advance.

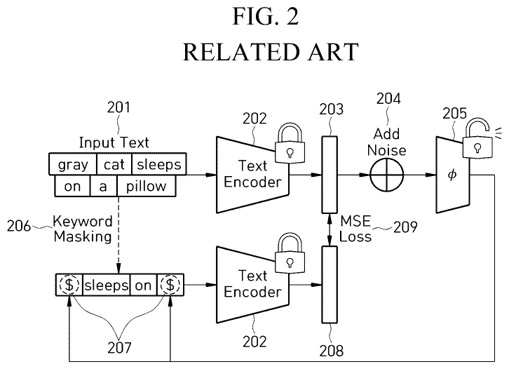

FIG. 2 is a diagram illustrating a method of training a zero-shot composed image retrieval system using only language according to the related art (reference: Geonmo Gu et al., “Language-only Efficient Training of Zero-shot Composed Image Retrieval,” https://doi.org/10.48550/arXiv.2312.01998, 2024).

As shown in a lock icon in FIG. 2, a portion trained through the above-described training method is a portion of the projection module 205 (the lock is open). A text encoder 202 is fixed (the lock is locked).

Input text 201 is converted into a full text embedding 203 through the text encoder 202. The full text embedding 203 is converted into a pseudo image-projected token 207 through a noise addition module 204 and a projection module 205.

Meanwhile, in the input text 201, words having specific parts of speech such as nouns and adjectives are replaced with the pseudo image-projected token 207 through a keyword masking process 206. The text in which some of the input text 201 is replaced with the image-projected token 207 is input into the text encoder 202 and converted into a pseudo image-projected embedding 208.

Finally, based on the full text embedding 203 and the pseudo image-projected embedding 208, a mean squared error (MSE) loss 209 is calculated, and the projection module 205 is trained using the calculated MSE loss 209 as a loss function.

The projection module 205 trained through the above-described training method is utilized in inference.

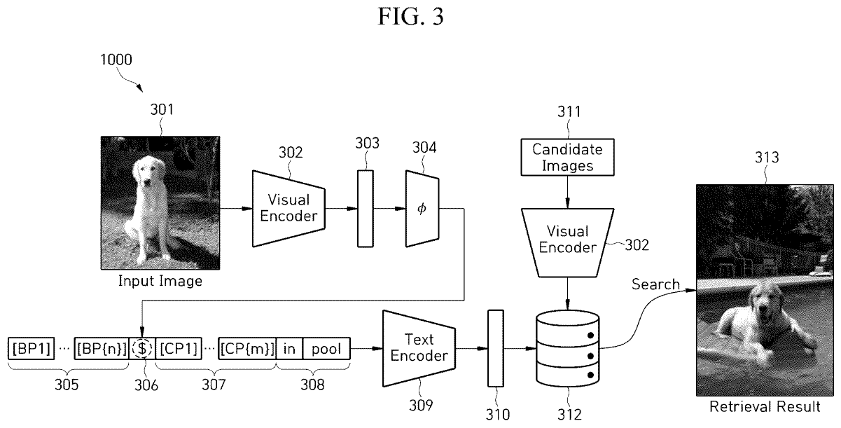

FIG. 3 is a diagram illustrating a method of a zero-shot composed image retrieval system according to one embodiment of the present invention.

In comparison with FIG. 1, a zero-shot composed image retrieval system 1000 according to one embodiment of the present invention has the characteristic of introducing a method of acquiring and using a base prompt 305 and a condition prompt 307 through training without fixing the base prompt 305 and the condition prompt 307. Through the above method, the adaptability and expandability of the model are strengthened, and as a result, there is an advantage of being able to perform composed image retrieval more accurately.

The zero-shot composed image retrieval system 1000 according to one embodiment of the present invention receives an input image 301 and input text when retrieving an image, generates a composed embedding based on the input image 301 and the input text, and retrieves a candidate image matching the input image 301 and the input text in the image database 312 using the composed embedding.

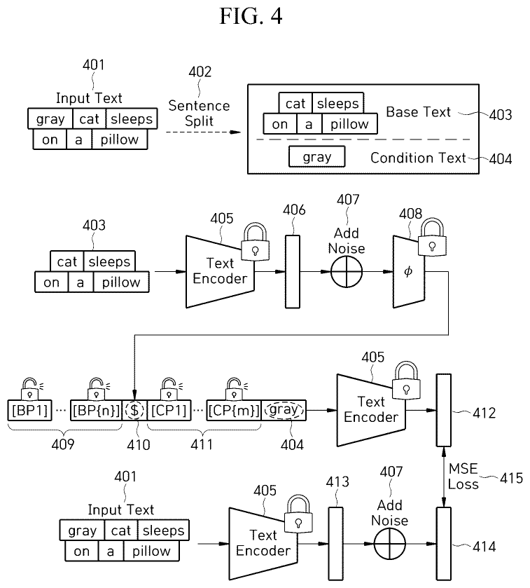

The zero-shot composed image retrieval system 1000 according to one embodiment of the present invention receives and processes only text when training the base prompt 305 and condition prompt 307 used for image retrieval (see FIG. 4).

The zero-shot composed image retrieval system 1000 uses a visual encoder 302 to encode the input image 301. Next, the zero-shot composed image retrieval system 1000 uses a text encoder 309 to encode a composed string (a string obtained by combining the base prompt, the image-projected token, the condition prompt, and a text modifier). Here, the visual encoder 302 and the text encoder 309 are multimodal encoders. That is, the visual encoder 302 and the text encoder 309 are encoders that generate multimodal embedding vectors of the same format (dimension) despite a difference in the input format (image, text). Next, since the visual encoder 302 and the text encoder 309 are multimodal encoders, the visual encoder 302 and the text encoder 309 are trained so that the embedding vectors generated by the visual encoder 302 and the text encoder 309 can be used interchangeably (compatibility of output vectors). That is, when semantically similar images and text are input into each encoder, the visual encoder 302 and the text encoder 309 are trained so that the embedding vector generated by the visual encoder 302 and the embedding vector generated by the text encoder 309 are semantically similar to each other. For example, the embedding vector generated by inputting an image of a dog into the visual encoder 302 and the embedding vector generated by inputting the text “Dog” into the text encoder 309 are similar to each other.

In the present invention, the multimodal encoders such as the visual encoder and the text encoder may be implemented as deep learning models.

When the input image 301 is given, the zero-shot composed image retrieval system 1000 inputs the input image 301 into the visual encoder 302 to acquire an image embedding 303. The zero-shot composed image retrieval system 1000 inputs the image embedding 303 into a pre-trained projection module 304 to generate an image-projected token 306. In one embodiment of the present invention, as the projection module 304, a projection module that has been previously trained through the training method as shown in FIG. 2 is used.

The zero-shot composed image retrieval system 1000 sequentially connects the base prompt 305, the image-projected token 306, the condition prompt 307, and the text modifier 308 to generate a composed string. In the present invention, the base prompt 305 is a prompt located in front of the image-projected token 306 in the composed string, and the condition prompt 307 is a prompt located in front of the text modifier 308. The condition prompt 307 is located between the image-projected token 306 and the text modifier 308 in the composed string and acts as a connector between image information and text information. The present invention has the effect of accurately performing the composed image retrieval through the characteristic that the base prompt 305 and the condition prompt 307 can be trained and the characteristic that the base prompt 305, the image-projected token 306, the condition prompt 307, and the text modifier 308 are arranged in sequence in the composed string.

For reference, the zero-shot composed image retrieval system 1000 may use the input text as it is as the text modifier 308 used to generate the composed string, or may use a value obtained by converting the input text into numeric information by using a predetermined function. The base prompt 305 and the condition prompt 307 are not fixed and can be trained. That is, the base prompt 305 and the condition prompt 307 can be trained. The base prompt 305 and the condition prompt 307 are each composed of embeddings of a certain length (n, m) that can be trained. The training method of the base prompt 305 and the condition prompt 307 will be described later with reference to FIG. 4.

Next, the zero-shot composed image retrieval system 1000 inputs the composed string into the text encoder 309 to generate a composed embedding 310.

Meanwhile, before the above-described process is performed, the zero-shot composed image retrieval system 1000 assumes that a group 311 of candidate images to be retrieved is input, the candidate image group 311 is input into the visual encoder 302 to acquire the embedding of each candidate image, and then the embedding of each candidate image is matched with the candidate image and stored in the image database 312. That is, the embedding of the candidate image group 311 to be retrieved is extracted in advance by the visual encoder 302 and stored in the image database 312 by matching the extracted embedding of the candidate image group 311 with the corresponding candidate image.

Finally, the zero-shot composed image retrieval system 1000 may extract a candidate image embedding with the highest similarity by comparing the composed embedding 310 with the embedding of the candidate image group 311 previously stored in the image database 312, and acquire one image that matches the extracted candidate image embedding and is most suitable for the input image 301 and the input text as an extraction result 313.

FIG. 4 is a diagram illustrating a method of training a zero-shot composed image retrieval system according to one embodiment of the present invention. This method may be performed by the zero-shot composed image retrieval system 1000.

The method of training the zero-shot composed image retrieval system according to one embodiment of the present invention is characterized in that, unlike the conventional training method, training is performed by designating a base prompt 409 and a condition prompt 411 as trainable parameters. As illustrated by the lock icon in FIG. 4, a text encoder 405 and a projection module 408 which have been completely trained in advance are used.

Unlike the retrieval method of FIG. 3 in which images and text are input, in the training method of FIG. 4, only text (training input text) is input, and the base text 403 among the training input text 401 serves as a pseudo-image.

For convenience of description, it is assumed that the embodiment of FIG. 4 is performed by a zero-shot composed image retrieval system 1000.

The zero-shot composed image retrieval system 1000 divides the training input text 401 into the base text 403 and the condition text 404 using a sentence-splitting module 402. Specifically, the zero-shot composed image retrieval system 1000 determines whether a word extracted from the training input text 401 is assigned to either of the base text and the condition text based on a predetermined criterion (e.g., part of speech), and combines the word assigned to each text group (base text, condition text) to generate the base text and the condition text.

The sentence-splitting module 402 of the zero-shot composed image retrieval system 1000 may determine the part of speech of the word included in the training input text 401, and when a word included in the training input text 401 is not a noun or an adjective, the word may be assigned to the base text 403. In this case, a verb or a preposition may be assigned to the base text 403.

In addition, when the word is determined to be a noun or adjective as a result of determining the part of speech of the word included in the training input text 401, the sentence-splitting module 402 may assign the word to the base text 403 or the condition text 404 according to a predetermined probability distribution (probability of assigning the word to the base text: p, probability of assigning the word to the condition text: 1-p). For example, the sentence-splitting module 402 may assign the noun or the adjective to the base text 403 with a probability of 80%, and to the condition text 404 with a probability of 20%.

The sentence-splitting module 402 may treat an adjective phrase as one adjective or a noun phrase as one noun, and assign the corresponding word to the base text 403 or the condition text 404 by apply the probability distribution. In this case, unlike FIG. 4, “gray cat” may be treated as one noun and may be assigned to the base text 403 or the condition text 404 as one unit (chunk).

Ultimately, the zero-shot composed image retrieval system 1000 assigns all words included in the training input text 401 to the base text 403 or the condition text 404.

The zero-shot composed image retrieval system 1000 inputs the base text 403 into the text encoder 405 to generate a base text embedding 406. The zero-shot composed image retrieval system 1000 adds noise to the base text embedding 406 through a noise addition module 407, and inputs the base text embedding 406 into a projection module 408 to generate a pseudo image-projected token 410. Here, the zero-shot composed image retrieval system 1000 uses the projection module 408 which has been completely trained in advance through the training method in FIG. 2.

The zero-shot composed image retrieval system 1000 sequentially combines the base prompt 409, the pseudo image-projected token 410, the condition prompt 411, and the condition text 404 to generate a composed string. Here, the numerical coding result of the condition text 404 may be used instead of the condition text 404. The zero-shot composed image retrieval system 1000 inputs the composed string into the text encoder 405 to generate a pseudo-image projected embedding 412. Here, the base prompt 409 and the condition prompt 411 are trained by the training method of FIG. 4.

Meanwhile, the zero-shot composed image retrieval system 1000 inputs the training input text 401 into the text encoder 405 to generate the training input text embedding 413, adds noise to the training input text embedding 413 by applying a noise addition module 407, and converts the training input text embedding 413 to the input text embedding 414 to which the noise is added.

Finally, the zero-shot composed image retrieval system 1000 trains the base prompt 409 and the condition prompt 411 using an MSE loss 415 between the pseudo image-projected embedding 412 and the input text embedding 414 to which the noise is added as a loss function.

Next, the zero-shot composed image retrieval system 1000 utilizes the base prompt 409 and the condition prompt 411 that have been trained through the training method of FIG. 4, together with the projection module 408 that has already been trained, in the inference of FIG. 3.

The above-described zero-shot composed image retrieval method and training method of the zero-shot composed image retrieval system have been illustrated and described as a series of blocks, but the invention is not limited to the order of the blocks, and some blocks may occur with other blocks in a different order from that illustrated and described in the present specification or at the same time. Also, various other branches, flow paths, and orders of blocks that achieve the same or similar result may be implemented. In addition, not all the illustrated blocks are necessarily required for implementation of the methods described in the present specification.

Meanwhile, in the description referring to FIGS. 3 and 4, each operation may be further divided into additional operations or combined into fewer operations according to the implementation example of the present invention. In addition, some operations may be omitted as needed, and the order among the operations may be changed. In addition, even if other omitted content is present, the content of FIGS. 1 and 2 may be applied to the content of FIGS. 3 and 4.

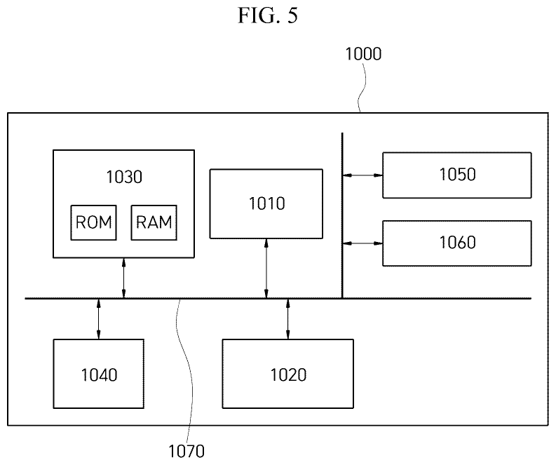

FIG. 5 is a diagram illustrating a configuration of a zero-shot composed image retrieval system for implementing a zero-shot composed image retrieval method according to one embodiment of the present invention.

The zero-shot composed image retrieval system 1000 according to one embodiment of the present invention may be implemented in the form of a computer system as illustrated in FIG. 5.

Referring to FIG. 5, the zero-shot composed image retrieval system 1000 may include at least one of at least one processor 1010 that performs communication via a bus 1070, a memory 1030, an input interface device 1050, an output interface device 1060, and a storage device 1040. The zero-shot composed image retrieval system 1000 may also further include a communication device 1020 coupled to a network.

The zero-shot composed image retrieval system 1000 illustrated in FIG. 5 is according to one embodiment, and the components of the zero-shot composed image retrieval system 1000 according to the present invention are not limited to the embodiment illustrated in FIG. 5, and may be added, changed, or deleted as needed.

The processor 1010 may be a central processing unit (CPU), or a semiconductor device that executes computer-readable commands stored in the memory 1030 or the storage device 1040. The memory 1030 and the storage device 1040 may include various forms of volatile or nonvolatile storage media. For example, the memory 1030 may include a read-only memory (ROM) and a random access memory (RAM). In the embodiment of the present disclosure, the memory 1030 may be located inside or outside the processor 1010, and may be connected to the processor 1010 through various means that are already known. The memory 1030 may be various forms of volatile or nonvolatile storage media, and for example, the memory 1030 may include a ROM or a RAM.

Accordingly, embodiments of the present invention may be implemented as a computer-implemented method or as a non-transitory computer-readable medium having computer-executable commands stored thereon. In one embodiment, when executed by the processor 1010, a method according to at least one aspect of the present disclosure may be performed according to the computer-readable commands.

The communication device 1020 may transmit or receive a wired signal or a wireless signal.

In addition, the zero-shot composed image retrieval method and the training method of the zero-shot composed image retrieval system according to the embodiment of the present invention may be implemented in the form of program commands that can be performed through various computer means and recorded on a computer-readable medium.

The computer-readable medium may include program commands, data files, data structures, etc., alone or in combination. The program commands recorded on the computer-readable medium may be specially designed and configured for the embodiments of the present invention, or may be known and available to those skilled in the art of computer software. The computer-readable recording medium may include a hardware device configured to store and execute the program commands. For example, the computer-readable recording medium may be a magnetic medium such as a hard disk, a floppy disk, or a magnetic tape, an optical medium such as a CD-ROM or a DVD, a magneto-optical medium such as a floptical disk, a ROM, a RAM, a flash memory, etc. The program commands may include not only machine language codes generated by a compiler, but also high-level language codes that can be executed by a computer through an interpreter, etc.

The processor 1010 is configured to, by executing computer-readable commands stored in the memory 1030 or the storage device 1040: acquire an image embedding by inputting an input image into a visual encoder; generate an image-projected token by inputting the image embedding into a projection module; generate a composed string based on a pre-trained base prompt, the image-projected token, a pre-trained condition prompt, and input text; generate a composed embedding by inputting the composed string into a text encoder; and extract one candidate image from among a plurality of candidate images that are retrieval targets using the composed embedding.

The processor 1010 may be configured to, in the process of extracting the candidate image, select an embedding having the highest similarity to the composed embedding among embeddings of the plurality of candidate images, and extract a candidate image matching the selected embedding.

The visual encoder and the text encoder may be multimodal encoders in which the formats of the output embeddings are the same.

The processor 1010 may be configured to, in the process of generating of the composed string: generate a text modifier based on input text, and generate the composed string by sequentially combining the base prompt, the image-projected token, the condition prompt, and the text modifier.

In order to train the base prompt and the condition prompt, the processor 1010 may be configured to: receive training input text and generate base text and condition text based on a word extracted from the training input text; generate a base text embedding by inputting the base text into the text encoder and generate a pseudo image-projected token by inputting the base text embedding into the projection module; generate a training composed string based on a pre-trained base prompt, the pseudo image-projected token, a pre-trained condition prompt, and the condition text and generate a training composed embedding by inputting the training composed string into the text encoder; generate a training input text embedding by inputting the training input text into the text encoder; and train the pre-trained base prompt and the pre-trained condition prompt using a loss function value calculated with the training composed embedding and the training input text embedding.

The loss function value may be an MSE loss between the training composed embedding and the training input text embedding.

The processor 1010 may be configured to, in the process of generating the base text and the condition text, assign the word to one of the base text and the condition text based on the part of speech of the word.

The processor 1010 may be configured to, in the process of generating the base text and the condition text, assign the word to one of the base text and the condition text according to a predetermined discrete probability distribution when the part of speech of the word is one of an adjective or a noun.

The processor 1010 may be configured to, in the process of generating the training composed embedding, generate the training composed string by sequentially combining the pre-trained base prompt, the pseudo image-projected token, the pre-trained condition prompt, and the condition text.

The processor 1010 may be configured to, in the process of generating the training composed embedding, generate the training composed string by sequentially combining the pre-trained base prompt, the pseudo image-projected token, the pre-trained condition prompt, and a numeric coding result of the condition text.

Meanwhile, even if the content is omitted in the description of FIG. 5, the content of FIGS. 1 to 4 may be applied to the content of FIG. 5.

According to the present invention, since the most similar target image can be retrieved based on the image and text (sentence), the zero-shot composed image retrieval method and system can be widely used in various application fields.

The present invention obtains excellent composed image retrieval results compared to the conventional techniques. The dataset used for evaluating the present invention is a composed image retrieval on common objects in context (CIRCO) dataset. The CIRCO dataset is an open domain benchmarking dataset for composed image retrieval (CIR) based on real images from the COCO unlabeled 2017 set. The CIRCO consists of a total of 1020 queries, randomly divided into 220 and 800 for the validation set and the test set, respectively, and contains an average of 4.53 ground truths per query. Below, the performance of CIRCO is evaluated using the mAP@K metric. Table 1 is a table obtained by comparing the composed image retrieval performance between the conventional techniques and the present invention.

TABLE 1

| | mAP@5 | mAP@10 | mAP@25 | mAP@50 |
|---|---|---|---|---|
| Pic2Word (Prior paper 1) | 8.72 | 9.51 | 10.64 | 11.29 |
| SEARLE | 11.68 | 12.73 | 14.33 | 15.12 |
| LinCIR (Prior paper 2) | 12.59 | 13.58 | 15.00 | 15.85 |
| LinCIR+ (Prior paper 2) | 12.42 | 13.48 | 14.98 | 15.87 |
| This invention | 13.25 | 14.28 | 15.99 | 16.84 |

The effects obtainable from the present invention are not limited to the effects mentioned above, and other effects that have not been mentioned will be clearly understood by those skilled in the art to which the present invention belongs from the description below.

For reference, the components according to the embodiment of the present invention may be implemented in the form of software or hardware such as a digital signal processor (DSP), a field programmable gate array (FPGA), or an application specific integrated circuit (ASIC), and may perform certain roles.

However, the “components” are not limited to software or hardware, and each component may be configured to be on an addressable storage medium and may be configured to execute one or more processors.

Thus, as an example, the components include components such as software components, object-oriented software components, class components, and task components, and processes, functions, properties, procedures, subroutines, segments of program code, drivers, firmware, microcode, circuitry, data, databases, data structures, tables, arrays, and variables.

The components and the functionality provided within those components may be combined into a smaller number of components or further separated into additional components.

Meanwhile, it will be understood that combinations of blocks in flowcharts or process flow diagrams may be performed by computer program instructions. Because these computer program instructions may be loaded into a processor of a general purpose computer, a special purpose computer, or another programmable data processing apparatus, the instructions, which are performed by a processor of a computer or another programmable data processing apparatus, create means for performing functions described in the flowchart block(s). The computer program instructions may also be loaded into a computer or another programmable data processing apparatus, and thus instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It should also be noted that in some alternative implementations, functions mentioned in blocks may occur out of order. For example, two blocks illustrated successively may actually be executed substantially concurrently, or the blocks may sometimes be performed in a reverse order according to the corresponding function.

Here, the term “module” used in the disclosure means a software component or hardware component such as an FPGA or ASIC, and performs a specific function. However, the term “module” is not limited to software or hardware. A “module” may be formed in an addressable storage medium, or may be formed to operate one or more processors. Thus, for example, the term “module” may include software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and “modules” may be associated with a smaller number of components and “modules,” or may be further divided into additional components and “modules.” Furthermore, the components and “modules” may be implemented to reproduce one or more CPUs in a device or security multimedia card.

Although the present invention has been described above with reference to preferred embodiments thereof, it will be understood by those skilled in the art that various modifications and changes may be made to the present invention without departing from the spirit and scope of the present invention as set forth in the claims below.

What is claimed is:

1. A zero-shot composed image retrieval method comprising:
acquiring, by a zero-shot composed image retrieval system, an image embedding by inputting an input image into a visual encoder;
generating, by the zero-shot composed image retrieval system, an image-projected token by inputting the image embedding into a projection module;
generating, by the zero-shot composed image retrieval system, a composed string based on a pre-trained base prompt, the image-projected token, a pre-trained condition prompt, and input text;
generating, by the zero-shot composed image retrieval system, a composed embedding by inputting the composed string into a text encoder; and
extracting, by the zero-shot composed image retrieval system, one candidate image from among a plurality of candidate images that are retrieval targets using the composed embedding.

2. The zero-shot composed image retrieval method of claim 1, wherein the visual encoder and the text encoder are multimodal encoders in which the formats of the output embeddings are the same.

3. The zero-shot composed image retrieval method of claim 1, wherein the generating of the composed string includes
generating, by the zero-shot composed image retrieval system, a text modifier based on input text; and
generating, by the zero-shot composed image retrieval system, the composed string by sequentially combining the base prompt, the image-projected token, the condition prompt, and the text modifier.

4. The zero-shot composed image retrieval method of claim 1, further comprising:
receiving, by the zero-shot composed image retrieval system, training input text and generating base text and condition text based on a word extracted from the training input text;
generating, by the zero-shot composed image retrieval system, a base text embedding by inputting the base text into the text encoder, and generating a pseudo image-projected token by inputting the base text embedding into the projection module;
generating, by the zero-shot composed image retrieval system, a training composed string based on a pre-trained base prompt, the pseudo image-projected token, a pre-trained condition prompt, and the condition text, and generating a training composed embedding by inputting the training composed string into the text encoder;
generating, by the zero-shot composed image retrieval system, a training input text embedding by inputting the training input text into the text encoder; and
training, by the zero-shot composed image retrieval system, the pre-trained base prompt and the pre-trained condition prompt using a loss function value calculated with the training composed embedding and the training input text embedding.

5. A method of training a zero-shot composed image retrieval system, the method comprising:
receiving, by the zero-shot composed image retrieval system, training input text, and generating base text and condition text based on a word extracted from the training input text;
generating, by the zero-shot composed image retrieval system, a base text embedding by inputting the base text into a text encoder, and generating a pseudo image-projected token by inputting the base text embedding into a projection module;
generating, by the zero-shot composed image retrieval system, a composed string based on a base prompt, the pseudo image-projected token, a condition prompt, and the condition text, and generating a composed embedding by inputting the composed string into the text encoder;
generating, by the zero-shot composed image retrieval system, a training input text embedding by inputting the training input text into the text encoder; and
training, by the zero-shot composed image retrieval system, the base prompt and the condition prompt using a loss function value calculated with the composed embedding and the training input text embedding.

6. The method of claim 5, wherein the generating of the base text and the condition text includes assigning the word to one of the base text and the condition text based on the part of speech of the word.

7. The method of claim 6, wherein the generating of the base text and the condition text includes assigning the word to one of the base text and the condition text according to a predetermined discrete probability distribution when the part of speech of the word is one of an adjective or a noun.

8. The method of claim 5, wherein the generating of the composed embedding includes generating, by the zero-shot composed image retrieval system, the composed string by sequentially combining the base prompt, the pseudo image-projected token, the condition prompt, and the condition text.

9. The method of claim 5, wherein the generating of the composed embedding includes generating, by the zero-shot composed image retrieval system, the composed string by sequentially combining the base prompt, the pseudo image-projected token, the condition prompt, and a numeric coding result of the condition text.

10. The method of claim 5, wherein the loss function value is a mean squared error (MSE) loss between the composed embedding and the training input text embedding.

11. A zero-shot composed image retrieval system comprising:
a memory configured to store computer-readable commands; and
at least one processor implemented to execute the commands,
wherein the at least one processor is configured to, by executing the commands,
acquire an image embedding by inputting an input image into a visual encoder,
generate an image-projected token by inputting the image embedding to a projection module,
generate a composed string based on a pre-trained base prompt, the image-projected token, a pre-trained condition prompt, and input text,
generate a composed embedding by inputting the composed string into a text encoder, and
extract one candidate image from among a plurality of candidate images that are retrieval targets using the composed embedding.

12. The zero-shot composed image retrieval system of claim 11, wherein the visual encoder and the text encoder are multimodal encoders in which the formats of the output embeddings are the same.

13. The zero-shot composed image retrieval system of claim 11, wherein the at least one processor is configured to, in the process of generating the composed string,
generate a text modifier based on input text; and
generate the composed string by sequentially combining the base prompt, the image-projected token, the condition prompt, and the text modifier.

14. The zero-shot composed image retrieval system of claim 11, wherein the at least one processor is configured to
receive training input text and generate base text and condition text based on a word extracted from the training input text,
generate a base text embedding by inputting the base text into the text encoder, and generate a pseudo image-projected token by inputting the base text embedding into the projection module,
generate a training composed string based on a pre-trained base prompt, the pseudo image-projected token, a pre-trained condition prompt, and the condition text, and generate a training composed embedding by inputting the training composed string into the text encoder; and
generate a training input text embedding by inputting the training input text into the text encoder, and train the pre-trained base prompt and the pre-trained condition prompt using a loss function value calculated with the training composed embedding and the training input text embedding.

15. The zero-shot composed image retrieval system of claim 14, wherein the at least one processor is configured to, in the process of generating the base text and the condition text, assign the word to one of the base text and the condition text based on the part of speech of the word.

16. The zero-shot composed image retrieval system of claim 15, wherein the at least one processor is configured to, in the process of generating the base text and the condition text, assign the word to one of the base text and the condition text according to a predetermined discrete probability distribution when the part of speech of the word is one of an adjective or a noun.

17. The zero-shot composed image retrieval system of claim 14, wherein the at least one processor is configured to, in the process of generating the training composed embedding, generate the training composed string by sequentially combining the pre-trained base prompt, the pseudo image-projected token, the pre-trained condition prompt, and the condition text.

18. The zero-shot composed image retrieval system of claim 14, wherein the at least one processor is configured to, in the process of the generating the training composed embedding, generate the composed string by sequentially combining the pre-trained base prompt, the pseudo image-projected token, the pre-trained condition prompt, and a numeric coding result of the condition text.

19. The zero-shot composed image retrieval system of claim 14, wherein the loss function value is an MSE loss between the training composed embedding and the training input text embedding.

20. The zero-shot composed image retrieval system of claim 11, wherein the at least one processor is configured to, in the process of extracting the candidate image, select an embedding having the highest similarity to the composed embedding among embeddings of the plurality of candidate images, and extract a candidate image matching the selected embedding.
